(19) United States
(12) Patent Application Publication
(10) Pub. No.: US 2008/0292216 A1
(43) Pub. Date: Nov. 27, 2008

(54) METHOD AND SYSTEM FOR PROCESSING IMAGES USING VARIABLE SIZE TILES

(76) Inventors: Clive Walker, Cambridge (GB); David Plowman, Great Chesterford (GB); Gary Keall, Long Clawson (GB)

Correspondence Address: MCANDREWS HELD & MALLOY, LTD, 500 WEST MADISON STREET, SUITE 3400, CHICAGO, IL, 60661, US

(21) Appl. No.: 11/867,292

(22) Filed: Oct. 4, 2007

Related U.S. Application Data
(60) Provisional application No. 60/939,908, filed on May 24, 2007.

(51) Int. Cl. G06K 9/20

(52) U.S. Cl. 382/298

(57) ABSTRACT

Methods and systems for processing images using variable size tiles are disclosed and may include receiving raw image data for processing and dividing the received raw image data into a plurality of variable size tiles for processing. The variable size tiles may be sequentially processed. Each of the variable size tiles may comprise a plurality of lines. A size of the variable size tiles may be adjusted based on a distortion in a corresponding region of the raw image data. The variable size tiles may be processed in an image sensor pipeline. A current variable size tile may overlap at least one neighboring variable size tile. At least one neighboring variable size tile may include one or more of: above the current variable size tile, below the current variable size tile, left of the current variable size tile, and right of the current variable size tile.

### CROSS-REFERENCE TO RELATED APPLICATIONS/INCORPORATION BY REFERENCE

This application makes reference to and claims priority to U.S. Provisional Application Ser. No. 60/939,908, filed on May 24, 2007, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to data processing. More specifically, certain embodiments of the invention relate to a method and system for processing images using variable size tiles.

### BACKGROUND OF THE INVENTION

Cellular phones have developed from large, expensive devices typically used only in cars and owned only by a small percentage of the population to miniature, inexpensive, and ubiquitous handheld devices, and are even more numerous than traditional land-line phones in countries with poor fixed-line infrastructure. Cellular handsets have incorporated text messaging, email, connection to the Internet, PDAs, and even personal computers.

Cellular phones with built-in cameras, or camera phones, have become prevalent in the mobile phone market, due to the low cost of CMOS image sensors and the ever increasing customer demand for more advanced cellular phones. As camera phones have become more widespread, their usefulness has been demonstrated in many applications, such as casual photography, but have also been utilized in more serious applications such as crime prevention, recording crimes as they occur, and news reporting.

Historically, the resolution of camera phones has been limited in comparison to typical digital cameras, due to the fact that they must be integrated into the small package of a cellular handset, limiting both the image sensor and lens size. In addition, because of the stringent power requirements of cellular handsets, large image sensors with advanced processing have been difficult to incorporate. However, due to advancements in image sensors, multimedia processors, and lens technology, the resolution of camera phones has steadily improved rivaling that of many digital cameras.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for processing images using variable size tiles, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary mobile multimedia system, in accordance with an embodiment of the invention.

FIG. 1B is a block diagram of an exemplary mobile multimedia processor, in accordance with an embodiment of the invention.

FIG. 2A is a block diagram of an exemplary application of image processing in a mobile communication device, in accordance with an embodiment of the invention.

FIG. 2B is a block diagram of an exemplary tile data imaging system, in accordance with an embodiment of the invention.

FIG. 3 is a block diagram of an exemplary linear data transfer to an image processor in a conventional system, in connection with an embodiment of the invention.

FIG. 4 is a block diagram of an exemplary tiled image data array, in accordance with an embodiment of the invention.

FIG. 5 is a flow diagram illustrating an exemplary process for image processing.

### DETAILED DESCRIPTION OF THE INVENTION

Certain aspects of the invention may be found in a method and system for processing images using variable size tiles. Exemplary aspects of the invention may comprise receiving raw image data for processing and dividing the received raw image data into a plurality of variable size tiles for processing. The variable size tiles may be sequentially processed. Each of the variable size tiles may comprise a plurality of lines. A size of the variable size tiles may be adjusted based on a determined distortion in a corresponding region of the raw image data. The variable size tiles may be processed in an image sensor pipeline. A current variable size tile may overlap at least one neighboring variable size tile. At least one neighboring data tile may include one or more of: above the current variable size tile, below the current variable size tile, left of the current variable size tile, and right of the current variable size tile.

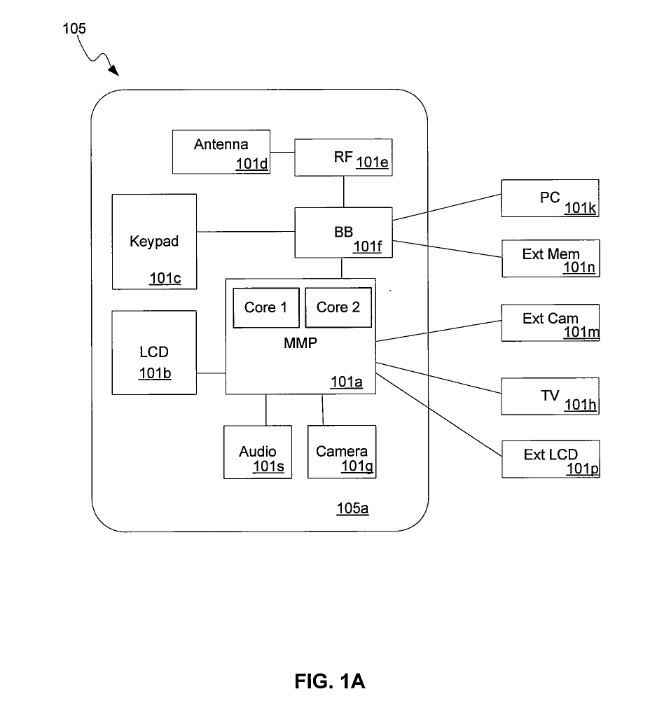

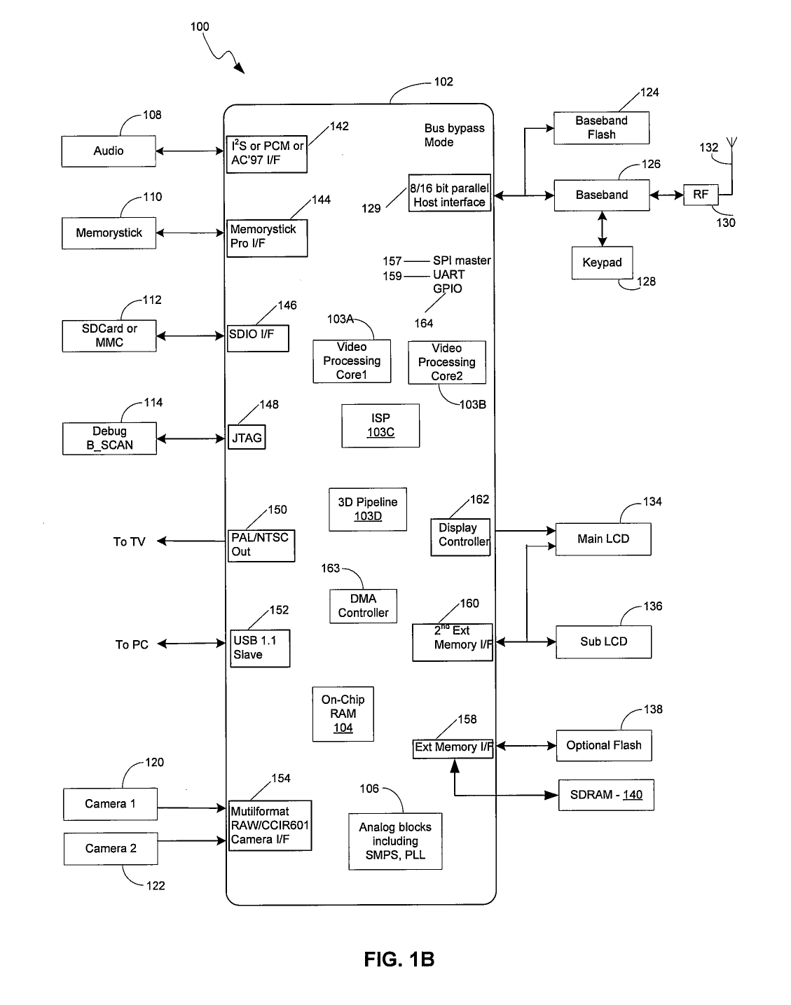

FIG. 1A is a block diagram of an exemplary mobile multimedia system, in accordance with an embodiment of the invention. Referring to FIG. 1A, there is shown a mobile multimedia system 105 that comprises a mobile multimedia device 105a, a TV 101h, a PC 101k, an external camera 101m, external memory 101n, and external LCD display 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, an LCD display 101b, a keypad 101c, and a camera 101g.

The MMP 101a may comprise suitable circuitry, logic, and/or code and may be adapted to perform video and/or multimedia processing for the mobile multimedia device 105a. The MMP 101a may further comprise a plurality of processor cores, indicated in FIG. 1A by Core 1 and Core2. The MMP 101a may also comprise integrated interfaces, which may be utilized to support one or more external devices coupled to the mobile multimedia device 105a. For example, the MMP 101a may support connections to a TV 101h, an external camera 101m, and an external LCD display 101p.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video data may be received from the external camera 101m, and image data may be received via the integrated camera 101g. During processing, the MMP 101a may utilize the external memory 101n for storing of processed data. Image data may be processed in tile format, which may reduce the memory requirements for buffering of data during processing. Conventional systems may process a plurality of entire lines of data, which may create excessive memory requirements for larger image sensors, with greater than 1 megapixel, for example. Processed audio data may be communicated to the audio block 101s and processed video data may be communicated to the LCD 101b or the external LCD 101p, for example. The keypad 101c may be utilized for communicating processing commands and/or other data, which may be required for audio or video data processing by the MMP 101a.

FIG. 1B is a block diagram of an exemplary mobile multimedia processor, in accordance with an embodiment of the invention. Referring to FIG. 1B, the mobile multimedia processor 102 may comprise suitable logic, circuitry and/or code that may be adapted to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise video processing cores 103A and 103B, an image sensor pipeline (ISP) 103C, a 3D pipeline 103D, on-chip RAM 104, an analog block 106, a direct memory access (DMA) controller 163, an audio interface (I/F) 142, a memory stick I/F 144, SD card I/F 146, JTAG I/F 148, TV output I/F 150, USB I/F 152, a camera I/F 154, and a host I/F 129. The mobile multimedia processor 102 may further comprise a serial peripheral interface (SPI) 157, a universal asynchronous receiver/transmitter (UART) I/F 159, general purpose input/output (GPIO) pins 164, a display controller 162, an external memory I/F 158, and a second external memory I/F 160.

The video processing cores 103A and 103B may comprise suitable circuitry, logic, and/or code and may be adapted to perform video processing of data. The on-chip RAM 104 and the SDRAM 140 may comprise suitable logic, circuitry and/or code that may be adapted to store data such as image or video data.

The image sensor pipeline (ISP) 103C may comprise suitable circuitry, logic and/or code that may enable the processing of image data. The ISP 103C may perform a plurality of processing techniques comprising filtering, demosaic, lens shading correction, defective pixel correction, white balance, image compensation, Bayer interpolation, color transformation, and post filtering, for example. The processing of image data may be performed on variable sized tiles, reducing the memory requirements of the ISP 103C processes.

The 3D pipeline 103D may comprise suitable circuitry, logic and/or code that may enable the processing of video data. The 3D pipeline 103D may perform a plurality of processing techniques comprising vertex processing, rasterizing, early-Z culling, interpolation, texture lookups, pixel shading, depth test, stencil operations and color blend, for example.

The analog block 106 may comprise a switch mode power supply (SMPS) block and a phase locked loop (PLL) block. In addition, the analog block 106 may comprise an on-chip SMPS controller, which may be adapted to generate its core voltage. The core voltage may be software programmable according to, for example, speed demands on the mobile multimedia processor 102, allowing further control of power management.

The analog block 106 may also comprise a plurality of PLL's that may be adapted to generate 195 kHz-200 MHz clocks, for example, for external devices. Other voltages and clock speeds may be utilized depending on the type of application. The mobile multimedia processor 102 may comprise a plurality of power modes of operation, for example, run, sleep, hibernate and power down. In accordance with an embodiment of the invention, the mobile multimedia processor 102 may comprise a bypass mode that may allow a host to access memory mapped peripherals in power down mode, for example. In bypass mode, the mobile multimedia processor 102 may be adapted to directly control the display during normal operation while giving a host the ability to maintain the display during standby mode.

The audio block 108 may comprise suitable logic, circuitry and/or code that may be adapted to communicate with the mobile multimedia processor 102 via an inter-IC sound (I²S), pulse code modulation (PCM) or audio codec (AC'97) interface 142 or other suitable interface, for example. In the case of an AC'97 and/or an I²S interface, suitable audio controller, processor and/or circuitry may be adapted to provide AC'97 and/or I²S audio output respectively, in either master or slave mode. In the case of the PCM interface, a suitable audio controller, processor and/or circuitry may be adapted to allow input and output of telephony or high quality stereo audio. The PCM audio controller, processor and/or circuitry may comprise independent transmit and receive first in first out (FIFO) buffers and may use DMA to further reduce processor overhead. The audio block 108 may also comprise an audio in, audio out port and a speaker/microphone port (not illustrated in FIG. 1B).

The mobile multimedia device 100 may comprise at least one portable memory input/output (I/O) block. In this regard, the memorystick block 110 may comprise suitable logic, circuitry and/or code that may be adapted to communicate with the mobile multimedia processor 102 via a memorystick pro interface 144, for example. The SD card block 112 may comprise suitable logic, circuitry and/or code that may be adapted to communicate with the mobile multimedia processor 102 via a SD input/output (I/O) interface 146, for example. A multimedia card (MMC) may also be utilized to communicate with the mobile multimedia processor 102 via the SD input/output (I/O) interface 146, for example. The mobile multimedia device 100 may comprise other portable memory I/O blocks such an xD I/O card.

The debug block 114 may comprise suitable logic, circuitry and/or code that may be adapted to communicate with the mobile multimedia processor 102 via a joint test action group (JTAG) interface 148, for example. The debug block 114 may be adapted to access the address space of the mobile multimedia processor 102 and may be adapted to perform boundary scans via an emulation interface. Other test access ports (TAPs) may be utilized. The phase alternate line (PAL)/national television standards committee (NTSC) TV output I/F 150 may be utilized for communication with a TV, and the universal serial bus (USB) 1.1, or other variant thereof, slave port I/F 152 may be utilized for communications with a PC, for example. The cameras 120 and/or 122 may comprise suitable logic, circuitry and/or code that may be adapted to communicate with the mobile multimedia processor 102 via a multiformat raw CCIR 601 camera interface 154, for example. The camera I/F 154 may utilize windowing and sub-sampling functions, for example, to connect the mobile multimedia processor 102 to a mobile TV front end.

The mobile multimedia processor 102 may also comprise a plurality of serial interfaces, such as the USB I/F 152, a serial peripheral interface (SPI) 157, and a universal asynchronous receiver/transmitter (UART) I/F 159 for Bluetooth or IrDA. The SPI master interface 157 may comprise suitable circuitry, logic, and/or code and may be utilized to control image sensors. Two chip selects may be provided, for example, to work in a polled mode with interrupts or via a DMA controller 163. Furthermore, the mobile multimedia processor 102 may comprise a plurality of general purpose I/O (GPIO) pins 164, which may be utilized for user defined I/O or to connect to the internal peripherals. The display controller 162 may comprise suitable circuitry, logic, and/or code and may be adapted to support multiple displays with XGA resolution, for example, and to handle 8/9/16/18/21-bit video data.

The mobile multimedia processor 102 may be connected via an 8/16 bit parallel host interface 129 to the same bus as the baseband processing block 126 uses to access the baseband flash memory 124. The host interface 129 may be adapted to provide two channels with independent address and data registers through which a host processor may read and/or write directly to the memory space of the mobile multimedia processor 102. The baseband processing block 126 may comprise suitable logic, circuitry and/or code that may be adapted to convert RF signals to baseband and communicate the baseband processed signals to the mobile multimedia processor 102 via the host interface 129, for example. The RF processing block 130 may comprise suitable logic, circuitry and/or code that may be adapted to receive signals via the antenna 132 and to communicate RF signals to the baseband processing block 126. The host interface 129 may comprise a dual software channel with a power efficient bypass mode.

The main LCD 134 may be adapted to receive data from the mobile multimedia processor 102 via a display controller 162 and/or from a second external memory interface 160, for example. The display controller 162 may comprise suitable logic, circuitry and/or code and may be adapted to drive an internal TV out function or be connected to a range of LCD's. The display controller 162 may be adapted to support a range of screen buffer formats and may utilize direct memory access (DMA) to access the buffer directly and increase video processing efficiency of the video processing cores 103A and 103B. Both NTSC and PAL raster formats may be generated by the display controller 162 for driving the TV out. Other formats, for example SECAM, may also be supported.

In one embodiment of the invention, the display controller 162 may be adapted to support a plurality of displays, such as an interlaced display, for example a TV, and/or a non-interlaced display, such as an LCD. The display controller 162 may also recognize and communicate a display type to the DMA controller 163. In this regard, the DMA controller 163 may fetch video data in an interlaced or non-interlaced fashion for communication to an interlaced or non-interlaced display coupled to the mobile multimedia processor 102 via the display controller 162.

The subsidiary LCD 136 may comprise suitable logic, circuitry and/or code that may be adapted to communicate with the mobile multimedia processor 102 via a second external memory interface 160, for example. The subsidiary LCD 136 may be used on a clamshell phone where the main LCD 134 may be inside and the subsidiary LCD 136 may be outside, for example. The mobile multimedia processor 102 may comprise a RGB external data bus. The mobile multimedia processor 102 may be adapted to scale image output with pixel level interpolation and a configurable refresh rate.

The optional flash memory 138 may comprise suitable logic, circuitry and/or code that may be adapted to communicate with the mobile multimedia processor 102 via an external memory interface 158, for example. The SDRAM 140 may comprise suitable logic, circuitry and/or code that may be adapted to receive data from the mobile multimedia processor 102 via the external memory I/F 158, for example. The external memory I/F 158 may be utilized by the mobile multimedia processor 102 to connect to the SDRAM 140, Flash memory 138, and/or external peripherals, for example. Control and timing information for the SDRAM 140 and other asynchronous devices may be configurable by the mobile multimedia processor 102.

The mobile multimedia processor 102 may further comprise a secondary memory interface 160 to connect to connect to memory-mapped LCD and external peripherals, for example. The secondary memory interface 160 may comprise suitable circuitry, logic, and/or code and may be utilized to connect the mobile multimedia processor 102 to slower devices without compromising the speed of external memory access. The secondary memory interface 160 may provide 16 data lines, for example, 6 chip select/address lines, and programmable bus timing for setup, access and hold times, for example. The mobile multimedia processor 102 may be adapted to provide support for NAND/NOR Flash including NAND boot and high speed direct memory access (DMA), for example.

In operation, the mobile multimedia processor 102 may be adapted to process image data in a variable size tile format. Processing may be performed by the ISP 103C using one or both of the video processing cores 103A and 103B. The on-chip RAM 104 and the SDRAM 140 may be utilized to store data during processing.

By processing data in tiles, the memory requirements for image processing may be reduced. In this manner, image processing may begin earlier and on smaller arrays of data, as opposed to waiting for a plurality of entire rows of the image data, as in conventional systems. The size of the tiles may be smaller in areas of the image where image distortion may be higher due to the image sensor optics in the cameras 120 and 122, around the edges, for example. Conversely, the tile size may be larger in areas where distortion may be lower, such as in the center of the image, for example.

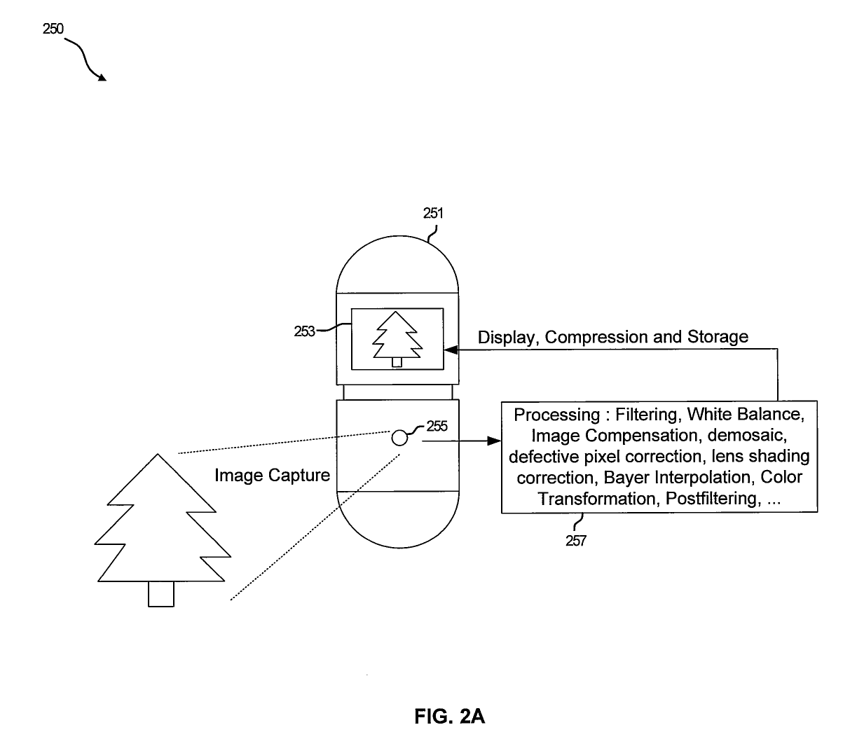

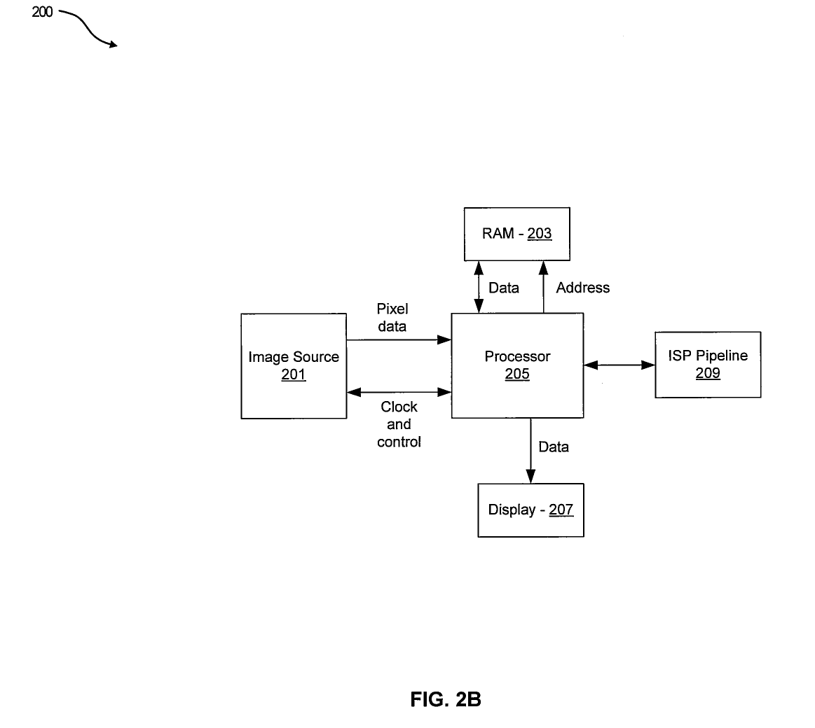

FIG. 2A is a block diagram of an exemplary application of image processing in a mobile communication device, in accordance with an embodiment of the invention. Referring to FIG. 2A, there is shown an image processing application 250 comprising a mobile communication device 251 with a display screen 253, an image source 255 and a processing block 257. The mobile communication device 251 may comprise suitable circuitry, logic and/or code for communicating over a cellular network and capturing, processing, storing and/or displaying an image generated by the image source 255. The display screen 253 may comprise suitable circuitry, logic and/or code for displaying an image generated by the image source 255 and the processing block 257. The image source 105 may comprise a multi-megapixel CCD, CMOS or related technology sensor array that may be enabled to detect a visual image and generate digital data representing that image.

The processing block 257 may comprise suitable circuitry, logic and/or code for processing the image data received from the image source 255. The processing steps, or image sensor pipeline (ISP), controlled by the processing block 257 may comprise, for example, filtering, demosaic, lens shading correction, defective pixel correction, white balance, image compensation, Bayer interpolation, color transformation, and post filtering. The processing block 257 may process image data tile-by-tile, processing individual tiles as they are received. Conventional systems may process an entire image, or a minimum number of entire lines of data, greatly increasing the memory requirements and reducing the speed of the system, especially as the number of pixels in images sensors continues to increase above ten million pixels.

In operation, the image source 255 in the mobile communication device 101 may perform an image capture. The image data may be transferred to the processor block 257 in tile format. In this manner, the processing of the data may commence before the entire image may be received, greatly increasing the speed, and reducing the memory requirements of the system. The processing may comprise filtering, white balance, image compensation, for example. The data may then be compressed, stored and/or displayed on the display screen 253.

FIG. 2B is a block diagram of an exemplary tile data image processing system, in accordance with an embodiment of the invention. Referring to FIG. 2B, there is shown an image processing system 200 comprising an image source 201, a RAM 203, a processor 205, a display 207 and an image sensor pipeline (ISP) block 209.

The image source 201 and the display 207 may be substantially similar to the image source 255 and the display screen 253, described with respect to FIG. 2A. The RAM 203 may comprise suitable circuitry, logic and/or code for storing data. The characteristics of the image source 201 may be measured at the time of manufacture, and the distortion of the optics across a resulting image may be stored in the RAM 203.

The processor 207 may comprise suitable circuitry, logic and/or code that may be enabled to send control signals to and receive data from the image source 201 and the RAM 203. The processor 205 may also be enabled to communicate data to the display 207. The image data may be processed in variable size tiles. The size of the tiles may be determined by the distortion in the image data. Smaller sized tiles may be utilized in areas of the image where there may be higher distortion, such as around the edges, for example. The tile sizes may be determined by the distortion characteristics stored in the RAM 203.

The ISP block 209 may comprise suitable circuitry, logic and/or code that may enable processing of image data generated by the image source 201. The ISP block 209 may comprise separate circuitry specifically for image processing tasks such as filtering, demosaic, lens shading correction, defective pixel correction, white balance, image compensation, Bayer interpolation, color transformation, and post filtering, for example. Each processing task may be performed by hardware in the ISP block 209, or by software stored in the RAM 203 and executed by the processor 205.

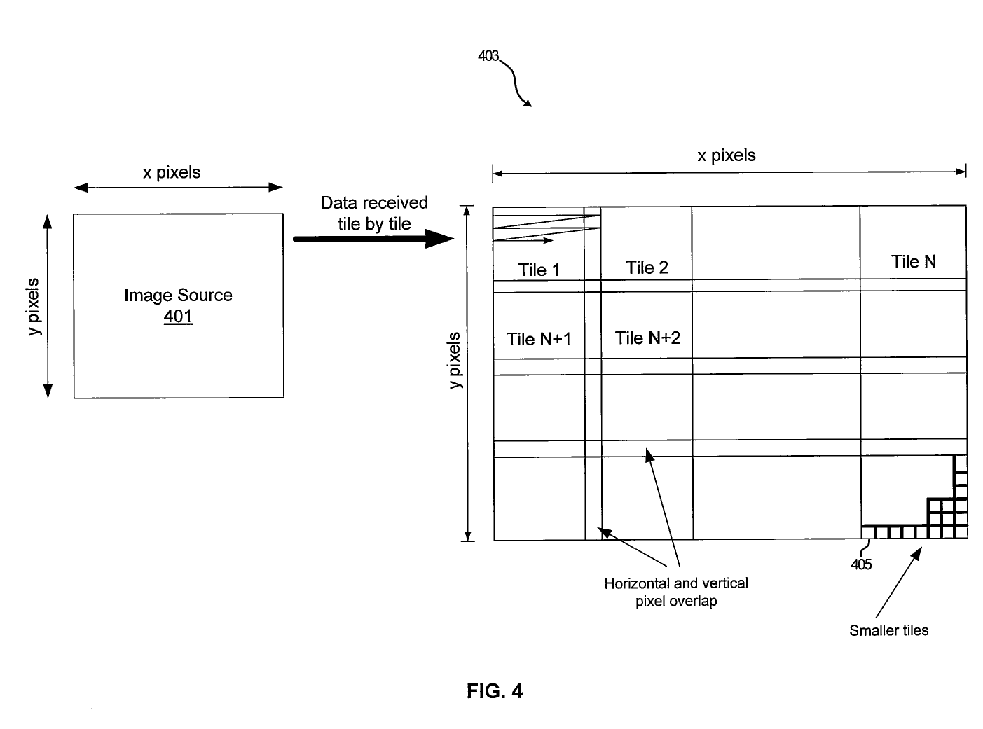

In operation, the processor 205 may receive tiled image data from the image source 201. The processor 205 may provide clock and control signals for synchronizing the data transfer from the image source 201. The data may be processed in the ISP block 209, and may be performed on tiles of data, as described further in FIG. 4. In addition, the tile sizes may vary over the image area, with smaller tile sizes in regions where more distortion may present due to the optics, for example.

The data may be stored in the RAM 203 prior to being communicated to the display 207. The processor 205 may communicate address data to the RAM 203 to determine where to read or write data in the RAM 203. Since the image processing may commence when the first tile may be received, as opposed to after the entire image file or a number of entire lines of data in conventional systems, the time required to process an entire image may be significantly reduced. Additionally, memory requirements may be reduced since large memory buffers may not be required for image tiles, in contrast to conventional systems which process multiple entire rows of data from an image, generating large amounts of data to be stored in buffers.

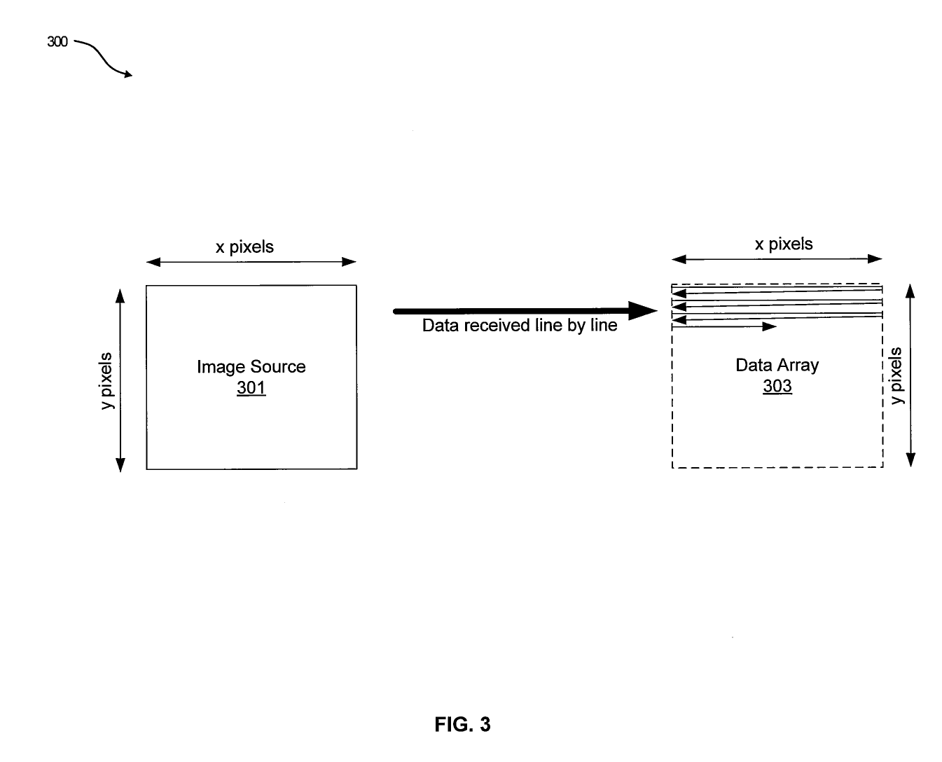

FIG. 3 is a block diagram of an exemplary linear data transfer to an image processor in a conventional system, in connection with an embodiment of the invention. Referring to FIG. 3, there is shown an image source 301 and an image data array 303. The image source 301 may be comprise a conventional imaging sensor, for example. The image data array 303 may comprise a data array with x columns and y rows of data, where x may be the number of pixels in the horizontal direction and y may be the number of pixels in the vertical direction.

In operation, the data from an image capture may be communicated to the image source 303 one line at a time. Each pixel data of a row may be transferred before the next row of data may be transferred. Because image processing techniques may be performed on two-dimensional blocks of data, the lines of data communicated from the image source 301 may be stored in a processor buffer or external memory until enough rows, at least 16, for example, have been read out to fill a row of processing blocks. When enough rows have been read out, a processor, may begin processing the data. As the number of pixels in image sensors continues to increase, this row storage may place excessive memory requirements on the system, which may be very undesirable in a handheld device, especially if cost is an important feature. In addition, since more data may be read out and stored in a buffer than what may be needed to start processing the first block, the speed of the system may be reduced.

FIG. 4 is a block diagram of an exemplary tiled image data array, in accordance with an embodiment of the invention. Referring to FIG. 4, there is shown an image source 401 and an image data array 403. The image source 401 may comprise a multi-megapixel CCD, CMOS or related technology sensor array, for example, that may be enabled to detect a visual image and generate digital data representing that image.

The data from the image source 401 may be received in tile format, as opposed to line-by-line. In this regard, the tiles or blocks of pixels may be addressed individually, as opposed to lines of pixels, which may greatly increase speed and reduce memory requirements of the image processing. The image source 401 may be from a cellular phone, a digital camera, a portable multimedia device, or any system incorporating an image sensor, for example.

The image data array 403 may comprise a data array with x columns and y rows of data, where x may be the number of pixels in the horizontal direction and y may be the number of pixels in the vertical direction. The image data array 403 may comprise a number of tiles of a variable width and height. For example, smaller tiles, as shown by the small tile 405 and similar adjacent tiles in the corner of the array, may be utilized in regions where the distortion in the image may be greater. Increased distortion may be due to imperfections in the optics, for example, of the image sensing system utilized to generate the image source 401. Each tile may overlap with neighboring tiles by a variable number of pixels, up to 64 for example, to reduce edge effects in the processing of adjacent tiles. The overlap of the smaller tiles in FIG. 4 is represented by thicker lines.

In operation, image data may be received from the image source 401 one block at a time. In this manner. the memory requirements in processing the data may be reduced since less than a single tile may require storage in a buffer before the data may be processed by a processor enabled to handle data in the appropriate tile size. The processing may comprise filtering, demosaic, lens shading correction, defective pixel correction, white balance, image compensation, Bayer interpolation, color transformation and post filtering, for example.

The data may be communicated to a display and/or compressed into JPEG, MPEG, or other format and stored in memory. In this manner, the memory requirements may be reduced and the speed may be increased, since the processing of the data may commence as soon as a single tile may be communicated from the image sensor, as opposed to a number of entire rows in a conventional design. Also, the amount of local memory in the processor, or cache, and the data traffic between the processor and the memory may be reduced due to the small size of the tile, as compared to the conventional process where data may be stored in RAM due to the large size of data from multiple rows.

The size of the image tiles may be variable across the image data array 403. For example, in areas of the image data where distortion may be higher, due to the image sensor optics, for example, the tile size may be reduced for more accurate image processing. Conversely, in regions of the image data where the distortion may be low, such as in the center, for example, the tile size may be larger for more efficient and higher speed image processing.

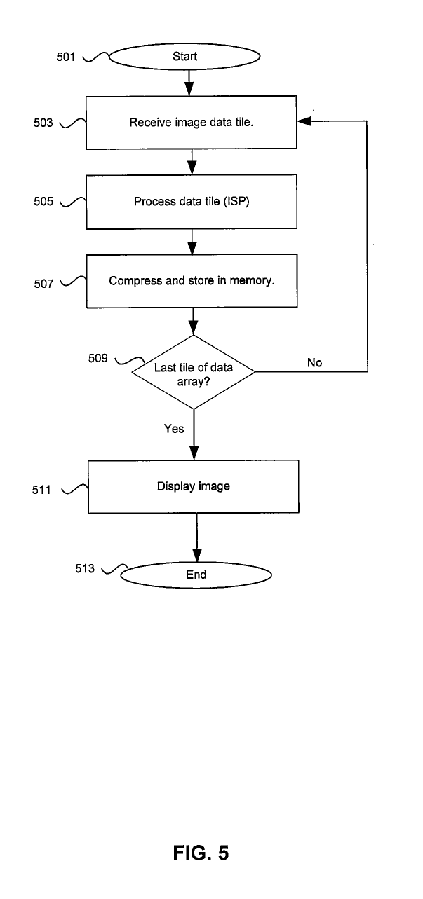

FIG. 5 is a flow diagram illustrating an exemplary process for image processing. Referring to FIG. 5, following start step 501, in step 503 an image data tile may be received by the processor 205 from the image source 201. In step 505, the data tile may be processed utilizing the ISP block 209 with techniques such as filtering, demosaic, lens shading correction, defective pixel correction, white balance, image compensation, Bayer interpolation, color transformation and post filtering, for example. In step 507, the processed data may be compressed and stored in memory, such as the RAM 203. In step 509, if the processed tile may be the last tile of the data array 403, the process may proceed to step 511 where the image may be displayed, followed by end step 513. If, in step 509, the processed tile may not be the last tile, the process may proceed to step 503, where the next data tile may be received by the processor 205. This loop may repeat until the final data tile may be processed and stored. The image may be displayed in step 511.

In an embodiment of the invention, a method and system are provided for processing images using variable size tiles and may comprise receiving raw image data for processing and dividing the received raw image data 301 into a plurality of variable size tiles for processing. The variable size tiles may be sequentially processed. Each of the variable size tiles may comprise a plurality of lines. A size of the variable size tiles may be adjusted based on a distortion in a corresponding region of the raw image data 401. The variable size tiles may be processed by an image sensor pipeline block 309. A current variable size tile may overlap at least one neighboring variable size tile. At least one neighboring data tile may include one or more of: above the current variable size tile, below the current variable size tile, left of the current variable size tile, and right of the current variable size tile.

Certain embodiments of the invention may comprise a machine-readable storage having stored thereon, a computer program having at least one code section for processing images using variable size tiles, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing images, the method comprising:
receiving raw image data for processing; and
dividing said received raw image data into a plurality of variable size tiles for said processing.

2. The method according to claim 1, comprising sequentially processing said variable size tiles.

3. The method according to claim 1, wherein each of said variable size tiles comprises a plurality of lines.

4. The method according to claim 1, comprising adjusting a size of said variable size tiles based on a distortion in a corresponding region of said raw image data.

5. The method according to claim 1, comprising processing said variable size tiles in an image sensor pipeline.

6. The method according to claim 1, wherein a current variable size tile overlaps at least one neighboring variable size tile.

7. The method according to claim 6, wherein said at least one neighboring variable size tile is one or more of: above said current variable size tiles, below said current variable size tile, left of said current variable size tile, and right of said current variable size tile.

8. A system for processing images, the system comprising:
one or more circuits that enable receiving raw image data for processing; and
said one or more circuits divides said received raw image data into a plurality of variable size tiles for said processing.

9. The system according to claim 8, wherein said one or more circuits sequentially processes said variable size tiles.

10. The system according to claim 8, wherein each of said variable size tiles comprises a plurality of lines.

11. The system according to claim 8, wherein said one or more circuits adjusts a size of said variable size tiles based on a distortion in a corresponding region of said raw image data.

12. The system according to claim 8, wherein said one or more circuits processes said variable size tiles in an image sensor pipeline.

13. The system according to claim 8, wherein a current variable size tile overlaps at least one neighboring variable size tile.

14. The system according to claim 13, wherein said at least one neighboring variable size tile is one or more of: above said current variable size tile, below said current variable size tile, left of said current variable size tile, and right of said current variable size tile.

15. A machine-readable storage having stored thereon, a computer program having at least one code section for data communication, the at least one code section being executable by a machine for causing the machine to perform steps comprising:
receiving raw image data for processing; and
dividing said received raw image data into a plurality of variable size tiles for said processing.

16. The machine readable storage according to claim 15, wherein said at least one code section comprises code for sequentially processing said variable size tiles.

17. The machine readable storage according to claim 15, wherein each of said variable size tiles comprises a plurality of lines.

18. The machine readable storage according to claim 15, wherein said at least one code section comprises code for adjusting a size of said variable size tiles based on a distortion in a corresponding region of said raw image data.

19. The machine readable storage according to claim 15, wherein said at least one code section comprises code for processing said variable size tiles in an image sensor pipeline.

20. The machine readable storage according to claim 15, wherein a current variable size tile overlaps at least one neighboring variable size tile.

21. The machine readable storage according to claim 20, wherein said at least one neighboring variable size tile is one or more of: above said current variable size tile, below said current variable size tile, left of said current variable size tile, and right of said current variable size tile.
